(19) United States
(12) Patent Application Publication
(10) Pub. No.: US 2005/0118509 A1
(43) Pub. Date: Jun. 2, 2005

(54) Secondary battery and method of manufacturing the same

(76) Inventors: Naoko Inagaki, Kanagawa (JP); Hiroyuki Akashi, Kanagawa (JP)

Correspondence Address: ROBERT J. DEPKE LEWIS T. STEADMAN;HOLLAND & KNIGHT LLC, 131 SOUTH DEARBORN, 30TH FLOOR, CHICAGO, IL, 60603, US

(21) Appl. No.: 10/948,017

(22) Filed: Sep. 23, 2004

(30) Foreign Application Priority Data
Sep. 25, 2003 (JP) JP2003-333763

(51) Int. Cl. H01M 2/16; H01M 4/58; H01M 4/40; H01M 10/04

(52) U.S. Cl. 429/247; 429/254; 429/231.4; 429/231.95; 29/623.1

(57) ABSTRACT

Provided are a secondary battery comprising a separator material capable of achieving a secondary battery with superior high temperature cycle characteristics and a higher energy density, and a method of manufacturing a secondary battery. A separator is evaluated and selected by thermal decomposition gas chromatography (thermal decomposition+GC/MS). In a suitable separator, the value of (the area of Peak 1 exhibiting 1-Decene)/(the area of Peak 2 exhibiting 1-Octene) in a total ion chromatogram (TIC) of the pyrolysate of the separator is 2.05 or less. More preferably, a material in which the value of (the area of Peak 1)/(the area of Peak 2) is 2.00 or less, the value of (the area of Peak 1)/(the area of Peak 3 exhibiting 1-Nonene) is 1.87 or less, and the value of (the area of Peak 3)/(the area of Peak 2) is 1.05 or less is selected, and is used as a separator.

### BACKGROUND OF THE INVENTION

1. Field of the Invention

The present invention relates to a secondary battery such as a nonaqueous secondary battery comprising, for example, an anode capable of doping and undoping lithium, a cathode, a separator disposed between the anode and the cathode, and a nonaqueous electrolyte, and a method of manufacturing the same.

2. Description of the Related Art

In recent years, the size and the weight of portable electronic devices such as camcorders, cellular phones and laptop computers have been reduced. As power sources suitable for the devices, specifically secondary batteries are often used.

In such a portable electronic device, it is desired to use a secondary battery with a small size, a light weight and a large capacity as a power source. Therefore, a development for improving the energy density of the secondary battery has been actively pursued.

In recent years, specifically a lithium-ion secondary battery in secondary batteries holds great promise as a battery which can obtain an extremely high energy density, compared to a conventional aqueous electrolyte secondary battery such as a lead-acid battery and a nickel cadmium battery. Moreover, the lithium-ion secondary battery has advantages that a discharge voltage is high, self-discharge is low, cycle characteristics are superior, and the energy density is high, so the lithium-ion ion secondary battery is used in various fields, and specifically in recent years, the lithium-ion secondary battery is used as a power source for various portable electronic devices such as cellular phones, notebook computers (personal computers) and digital cameras which are often used outdoors. Even if these electronic devices are in a room such as a car, a cafeteria or an office, they may be left, for example, in a position near a window through which strong sunlight streams. For example, in summer, the temperature on the dashboard of a car may climb to 80° C. or more. Moreover, in recent years, in accordance with the widespread use of portable electronic devices, more users of the portable electronic devices bring the devices for overseas trips, overseas business trips and the like, therefore, it is not uncommon to use the portable electronic devices under the scorching sun in the Middle East or under high temperature and humidity conditions in Southeast Asia. Under the circumstances, even if the lithium-ion secondary battery is left under high temperature conditions for a long time, or is charged or discharged under high temperature conditions, the lithium-ion secondary battery is strongly required to prevent deterioration in battery characteristics, that is, to improve high temperature storage characteristics and high temperature cycle characteristics.

However, when a conventional lithium-ion secondary battery is used under high temperature conditions for a long time, or when a charge-discharge cycle is performed under high temperature conditions, deterioration in the characteristics of the conventional lithium-ion secondary battery may occur.

Some causes of the deterioration in the characteristics due to high temperature conditions can be considered, and not all the mechanisms causing the deterioration have been clarified. However, in general, it is considered that a part of a nonaqueous electrolyte is decomposed under high temperature conditions, thereby the decomposed nonaqueous electrolyte adversely affects battery characteristics. Moreover, it is presumed that there may be the cases where an extremely small amount of a metal component is eluted to cause a very small short circuit.

The degree of influence of these phenomena on the battery characteristics may be changed according to the chemical structure of the separator including a three-dimensional structure such as the composition, the physical properties, the thickness and the cross-link, and it is presumed that at least one of main factors of deterioration in high temperature characteristics does not have an influence only on a single electrode of the cathode or the anode, and the one of the main factors results from an interaction between the cathode and the anode. In general, as the material of the separator used in the nonaqueous secondary battery, a general-purpose porous polyethylene film which is relatively low cost, and has good production stability, superior electrochemical stability and wide variations is often used. In the general-purpose polyethylene film, the storage characteristics or charge-discharge cycle characteristics under high temperature conditions are not bad; however, in accordance with an increase in the capacity of the battery, it is difficult to secure sufficient high temperature characteristics. In order to solve the problem, it is considered to increase the thickness of the separator.

However, by the above method, high temperature characteristics cannot be sufficiently maintained or improved, and specifically when a thick separator is used, the amount of an active material filled in a cell must be reduced, thereby it is difficult to achieve a secondary battery with a large capacity (that is, a high energy density). Moreover, a new separator material such as polyimide has a large number of unknown factors in the material (or electrochemical properties in the secondary battery), and the material is generally expensive, so it interferes with a reduction in cost. In this point of view, it is desired to use a general-purpose polyethylene-based material which has been used.

However, when the general-purpose polyethylene-based material is used for the separator, a secondary battery using the material may have insufficient high temperature characteristics, and such high temperature characteristics cannot be evaluated until the battery is completed. Therefore, in the case where after the secondary battery is completed, the high temperature characteristics are evaluated, and it is found out that the evaluation result is not practically sufficient, various material resources used in all processes, time, cost or the like for processes required for manufacturing are wasted. Moreover, even if separator materials are manufactured in the same lot, significant variations in electrochemical material properties which appear when the separator materials are included in secondary batteries within a tolerance determined as a material may result. However, there has been no technique of accurately evaluating the material properties, that is, the chemical structure of the separator material as numeric values before the separator material is included in the secondary battery.

### SUMMARY OF THE INVENTION

In view of the foregoing, it is an object of the invention to provide a method of manufacturing a secondary battery comprising the step of evaluating a separator material, in which a separator material capable of achieving a secondary battery with superior high temperature cycle characteristics and a high energy density can be accurately evaluated before including the separator material to complete a secondary battery, and a secondary battery manufactured through the method.

A method of manufacturing a secondary battery according to the invention comprises the step of evaluating the chemical structure of a separator material disposed between an anode and a cathode in a secondary battery by thermal decomposition gas chromatography (thermal decomposition+GC/MS) to select a material used as a separator in the secondary battery on the basis of evaluation, wherein the chemical structure of the separator material is evaluated on the basis of a total ion chromatogram of the pyrolysate of the separator material.

Moreover, in a secondary battery according to the invention, the value of the integral of Peak 1 exhibiting an MS spectrum of 1-Decene/the integral of Peak 2 exhibiting an MS spectrum of 1-Octene as a ratio between the integral of Peak 1 and the integral of Peak 2 in a total ion chromatogram of the pyrolysate of the material of the separator is 2.00 or less. Moreover, in the secondary battery according to the invention, the value of the integral of Peak 3 exhibiting an MS spectrum of 1-Nonene/the integral of Peak 2 exhibiting an MS spectrum of 1-Octene as a ratio between the integral of Peak 3 and the integral of Peak 2 in the total ion chromatogram of the pyrolysate of the material of the separator is 1.05 or less. Further, in the secondary battery according to the invention, the value of the integral of Peak 1 exhibiting an MS spectrum of 1-Decene/the integral of Peak 3 exhibiting an MS spectrum of 1-Nonene as a ratio between the integral of Peak 1 and the integral of Peak 3 in the total ion chromatogram of the pyrolysate of the material of the separator is 1.87 or less.

In the method of manufacturing a secondary battery or the secondary battery according to the invention, the chemical structure of the separator disposed between an anode and a cathode in the secondary battery is evaluated on the basis of the total ion chromatogram of the pyrolysate of the material of the separator, so before including the separator in the secondary battery, the chemical structure of the separator can be accurately evaluated whether the chemical structure of the separator contributes to an improvement in high temperature cycle characteristics of the secondary battery.

A main part in the step of evaluating, the method of manufacturing a secondary battery and the secondary battery according to the invention is mainly confirmed in experiments, so the main principle that the chemical structure of the separator obtained on the basis of the total ion chromatogram of the pyrolysate of the material of the separator as described above contributes to an improvement in high temperature cycle characteristics of the secondary battery has not been proved yet; however, it is presumed that it is because of the following effect.

There may be cases where a very small amount of cyclic olefin such as norbornene as a material before polymerization is included in a polyethylene-based separator, and there is a difference in the chemical structure of polyethylene after polymerization including a three-dimensional structure such as the cross-link structure between the case where the cyclic olefin is included and the case where the cyclic olefin is not included. Moreover, in the case where a very small amount of cyclic olefin such as norbornene as a material before polymerization is included, a part of the cyclic olefin may be changed to be acyclic olefin after polymerization, and the cross-link structure of the component is not always uniform, thereby the influence of an extremely small amount of a metal component which causes a very small short circuit on an interaction between the cathode and the anode is dependent on the cross-link structure. Therefore, it is considered that the above effect causes variations in high temperature characteristics of a secondary battery when the separator is included in the secondary battery. In consideration of the effect, it is presumed that when the information of the chemical structure of the separator is obtained on the basis of the total ion chromatogram of the pyrolysate of the separator after cross-linking, the high temperature characteristics in the case where the separator is included in the secondary battery can be evaluated beforehand according to the obtained information.

In the method of manufacturing a secondary battery comprising the step of evaluating a separator material and the secondary battery according to the invention, the chemical structure of the separator material can be accurately evaluated before the separator is included in the secondary battery by the TIC obtained by the thermal decomposition gas chromatography, so a secondary battery with superior high temperature characteristics can be reliably achieved.

Other and further objects, features and advantages of the invention will appear more fully from the following description.

### BRIEF DESCRIPTION OF THE DRAWINGS

FIG. 1 is a graph showing a total ion chromatogram of the pyrolysate of a separator;

FIG. 2 is an enlarged graph showing a peak part of the total ion chromatogram of the pyrolysate of the separator;

FIG. 3 is a graph showing an integration method (integration range) of a peak value;

FIG. 4 is a graph showing an MS spectrum of Peak 1 as Spectrum A;

FIG. 5 is a graph showing an MS spectrum of Peak 2 as Spectrum B;

FIG. 6 is a graph showing an MS spectrum of Peak 3 as Spectrum C;

FIG. 7 is a table showing a ratio of peak areas (integrals) of each pyrolysate;

FIG. 8 is a table showing measurement results of high temperature cycle discharge capacity retention ratios in Examples 1 through 3 and Comparative Examples 1 and 2;

FIG. 9 is a table showing measurement results of high temperature cycle discharge capacity retention ratios in Examples 4 through 6 and Comparative Examples 3 and 4; and

FIG. 10 is a table showing measurement results of high temperature cycle discharge capacity retention ratios in Examples 7 through 9 and Comparative Examples 5 and 6.

### DETAILED DESCRIPTION OF THE PREFERRED EMBODIMENTS

A method of manufacturing a secondary battery comprising the step of evaluating a separator according to the invention, and a secondary battery according to an embodiment will be described in detail below.

As an anode which can be used in a secondary battery manufactured by using a separator selected by the step of evaluating a separator, a carbonaceous material capable of inserting and extracting lithium, a metal capable of forming an alloy with lithium, or an alloy compound including the metal is cited. The alloy compound herein is a compound represented by a chemical formula MₓM′_{y}Li_{z} where a metal element capable of forming an alloy with lithium is M (M′ is one or more metal elements except for Li and M, the value of x is larger than 0, and the values of y and z are 0 or more). Moreover, in the invention, as the metal element, elements such as B, Si and As which are metalloid elements are included. Examples of the metal element includes metal elements Mg, B, Al, Ga, In, Si, Ge, Sn, Pb, Sb, Bi, Cd, Ag, Zn, Hf, Zr and Y and alloy compounds thereof, Li—Al, Li—Al-M (M include one or more elements selected from Group 2A elements, Group 3B elements, Group 4B elements and transition metal elements), AlSb, CuMgSb and the like. As the element capable of forming an alloy with lithium, a Group 4B representative element is preferably used, and more preferably Si or Sn is used. Examples of the alloy compound include a compound represented by MxSi or MxSn (M is one or more metal elements except for Si or Sn), and more specifically SiB₄, SiB₆, Mg₂Si, Mg₂Sn, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂ and the like.

Moreover, a compound including a Group 4B element except for carbon and one or more nonmetal elements can be used as the anode of the invention. Examples of the compound include SiC, Si3N₄, Si₂N₂O, Ge₂N₂O, SiOₓ(O<x≦2), SnOₓ(O<x≦2), LiSiO, LiSnO and the like. As a method of forming the above anode material, for example, mechanical alloying, a method of mixing materials of the compound to heat the mixed materials in an inert atmosphere, melt spinning, gas atomization, water atomization and the like can be used. However, the method is not specifically limited to them. Moreover, the above anode materials may be pulverized or not. Further, in, the anode of the invention, two or more kinds of the above materials may be mixed.

After forming a battery, lithium may be electrochemically doped into the above material in the battery, or after or before forming the battery, lithium may be electrochemically doped through supplying from a cathode or a lithium source except for the cathode. Further, a lithium-containing material is synthesized, and when forming the battery, the synthesized material may be included in the anode.

The anode may include any material in addition to the above anode active material and a binder. For example, a carbonaceous material may be included. As the carbonaceous material, at least one kind selected from the group consisting of non-graphitizable carbon, artificial graphite, natural graphite, kinds of pyrolytic carbon, kinds of coke (pitch coke, needle coke, petroleum coke and the like), kinds of graphite, kinds of glass-like carbon, a fired high molecular weight organic compound body (a phenolic resin, a furan resin or the like fired at an adequate temperature to be carbonized), activated carbon, filamentous carbon and the like can be used. Moreover, a material not contributing to charge and discharge may be included. When the anode is formed of such materials, a common binder or the like can be added.

As the electrolyte, a nonaqueous electrolyte solution in which an electrolyte salt is dissolved in a nonaqueous solvent, a solid electrolyte including an electrolyte salt, a gel electrolyte in which an organic macromolecule is impregnated with a nonaqueous solvent and an electrolyte salt, or the like can be used.

The nonaqueous electrolyte solution is prepared through combining an organic solvent and an electrolyte as appropriate, and any organic solvent used in a battery of this kind can be used. For example, propylene carbonate, ethylene carbonate, diethyl carbonate, dimethyl carbonate, 1,2-dimethoxyethane, 1,2-diethoxyethane, γ-butyrolactone, tetrahydrofuran 2-methyltetrahydrofuran, 1,3-dioxolane, 4-methyl- 1,3-dioxolane, diethyl ether, sulfolane, methylsulfolane, acetonitrile, propionitrile, anisole, acetate, butyrate, propionate or the like can be used.

As the solid electrolyte, either an inorganic solid electrolyte or a solid high molecular weight electrolyte can be used, as long as the electrolyte has lithium ion conductivity. As the inorganic solid electrolyte, lithium nitride and lithium iodide are cited. The solid high molecular weight electrolyte is made of an electrolyte salt and a high molecular weight compound in which the electronic salt is dissolved, and as the high molecular weight compound, an ether-based macromolecule such as poly(ethylene oxide) or a cross-link including poly(ethylene oxide), a poly(methacrylate) ester, an acrylate or the like can be used by itself, or through copolymerizing or mixing it in a molecule.

As a matrix of the gel electrolyte, various macromolecules which can absorb the above nonaqueous electrolyte solution to be gelatinized can be used. For example, a fluorine-based macromolecule such as poly(vinylidene fluoride) or poly(vinylidene fluoride-co-hexafluoropropylene), an ether-based macromolecule such as poly(ethylene oxide) or a cross-link including poly(ethylene oxide), poly(acrylonitrile) and the like can be used. More specifically, in terms of stability of oxidation-reduction, the flurorine-based macromolecule is preferable. The gel electrolyte includes the electrolyte salt so as to have ion conductivity. As the electrolyte salt used in the above electrolyte, any electrolyte salt used in a battery of this kind can be used. Examples of the electrolyte salt include LiClO₄, LiAsF₆, LiPF₆, LiBF₄, LiB(C₆H₅)₄, CH₃SO₃Li, CF₃SO₃Li, LiCl, LiBr and the like.

The cathode can include a metal oxide, a metal sulfide or a specific polymer as a cathode active material depending upon the kind of a targeted battery. As the cathode active material, a metal sulfide or a metal oxide not including lithium such as TiS₂, MoS₂, NbSe₂ or V₂0₅, a lithium complex oxide represented by LiₓMO₂ (where M represents one or more kinds of transition metals, and the value of x depends upon charge-discharge conditions of the battery, and is generally 0.05<x≦1.10) as a main body can be used.

As the transition metal M of the lithium complex oxide, Co, Ni, Mn and the like are preferable. Specific examples of the lithium complex oxide include LiCo₂, LiNiO₂, LiₓNi_{y}Co_{-1-y}0₂ (where the values of x and y depend upon charge-discharge conditions of the battery, and are generally 0<x<1 and 0.7<y<1.02, respectively), a lithium-manganese complex oxide with a spinel structure and the like. These lithium complex oxides are cathode active materials which can generate a high voltage and have a superior energy density. For the cathode, a mixture including a plurality of kinds of the cathode active materials may be used. Moreover, when the above cathode active material is used to form the cathode, a general conductor or a general binder can be added.

The outer shape (battery shape) of the secondary battery according to the embodiment is not limited to specific kinds. The secondary battery according to the embodiment can have various shapes such as a cylindrical shape, a prismatic shape, a coin shape, a button shape or a film shape. Moreover, it is unnecessary that all lithium existing in one battery system is supplied from the cathode or the anode, and in a step of manufacturing an electrode of the battery system or the whole battery system, lithium may be electrochemically doped into the cathode or the anode. Further, the secondary battery according to the embodiment may be designed so as to precipitate a light metal on the anode during charge, and the capacity of the anode may include a capacity component by precipitation and dissolution of the above light metal. As the light metal, a light metal including Li is preferable.

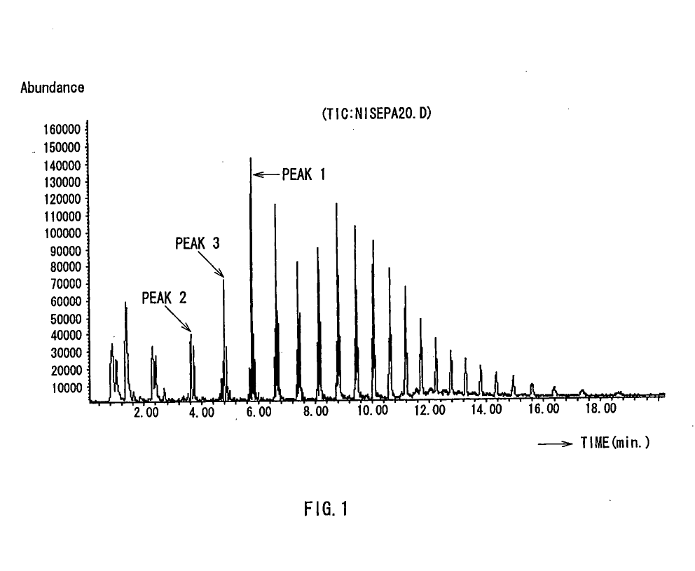

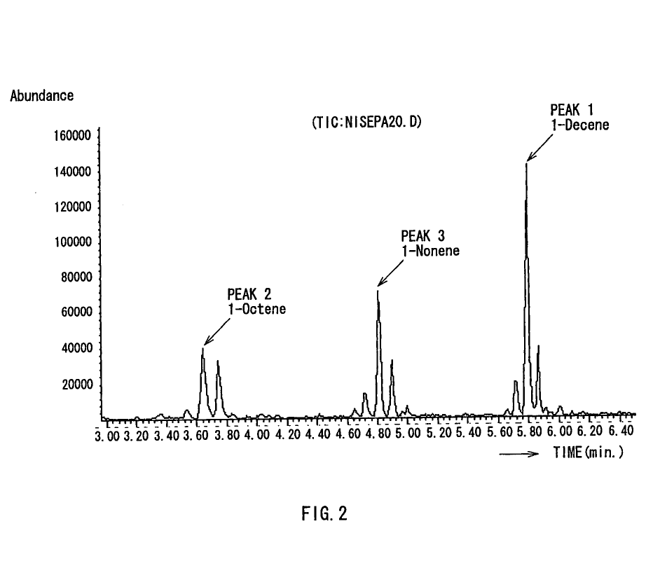

The secondary battery according to the embodiment comprises the cathode, the anode, the separator disposed between the cathode and the anode, and the nonaqueous electrolyte, and in the separator in a pyrolysate which can be obtained when the separator is measured and evaluated under Condition 1 by thermal decomposition gas chromatography (thermal decomposition+GC/MS), the value of (the area of Peak 1)/(the area of Peak 2) in a total ion chromatogram (hereinafter referred to as TIC) as shown in FIGS. 1 and 2 is 2.05 or less. In other words, such a material is evaluated and selected to be used in the secondary battery as the separator.

More preferably, the value of (the area of Peak 1)/(the area of Peak 2) is 2.00 or less, the value of (the area of Peak 1)/(the area of Peak 3) is 1.87 or less, and the value of (the area of Peak 3)/(the area of Peak 2) is 1.05 or less.

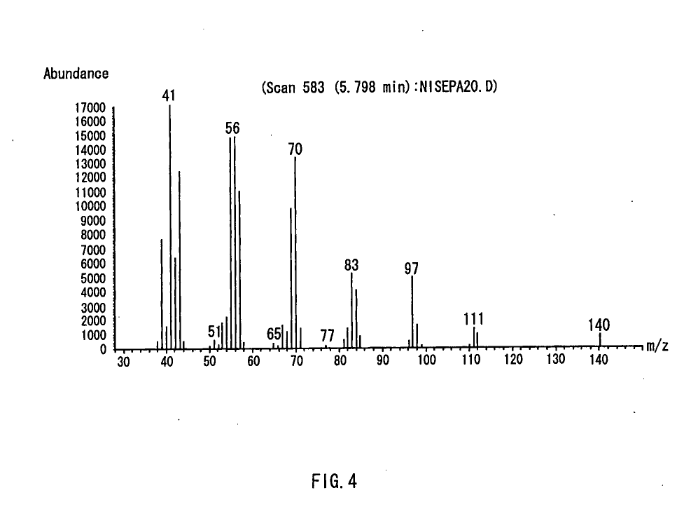

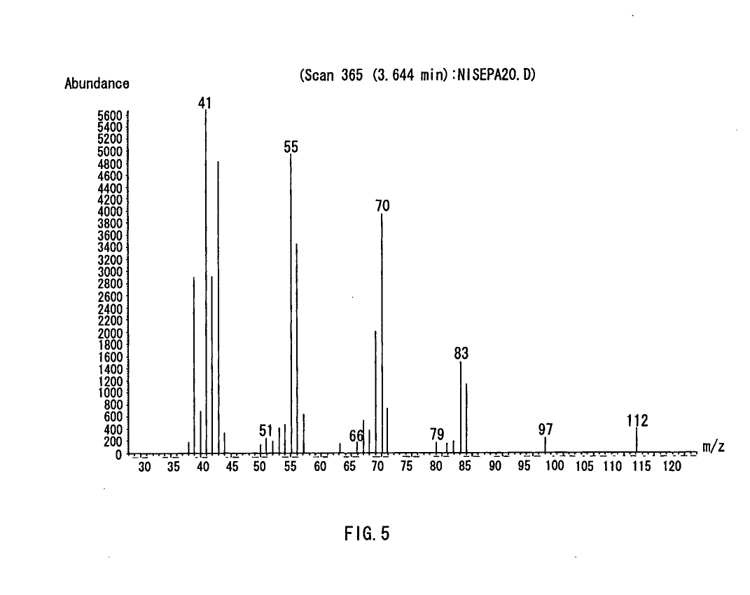

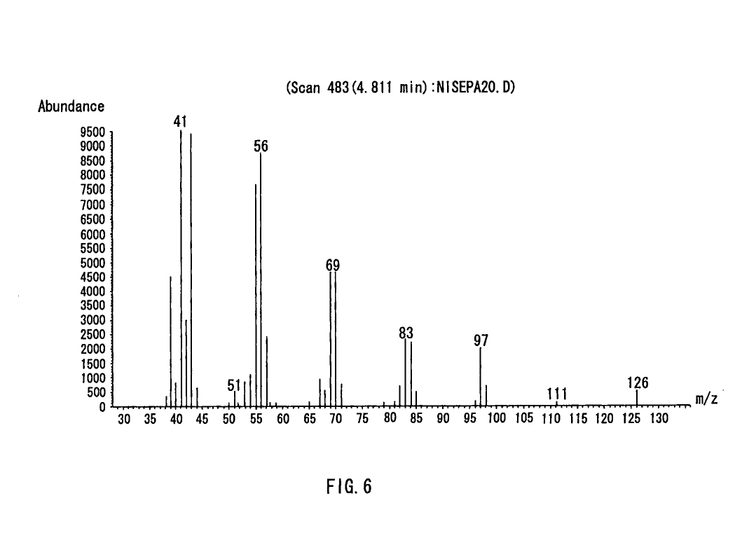

Herein, Peak 1 represents an MS spectrum represented by Spectrum A shown in FIG. 4, and is attributed to 1-Decene represented by Chemical Formula 1; CH₂═CHCH₂CH₂CH₂CH₂CH₂CH₂CH₂CH₃, and Peak 2 represents an MS spectrum represented by Spectrum B shown in FIG. 5, and is attributed to 1-Octene represented by Chemical Formula 2; CH₂═CHCH₂CH₂CH₂CH₂CH₂CH₃, and Peak 3 represents an MS spectrum represented by Spectrum C shown in FIG. 6, and is attributed to 1-Nonene represented by Chemical Formula 3; CH₂═CHCH₂CH₂CH₂CH₂CH₂CH₂CH₃.

For the above evaluation by the TIC, measurement is preferably performed under the conditions below.

<Condition 1>

Unit: HP5890/597X GC/MS (X=1, 2, 3) or HP6890/5973
Column: HP5MS or low bleed 5%-diphenyl-95%-dimethyl siloxane column
Thermal decomposition temperature and time: 590° C., 12 sec.
GC inlet temperature: 250° C.
Split ratio: 50:1
GC initial temperature: 30° C. (kept for 2 min.)
GC heating rate: 20° C. per min.
GC final temperature: 280° C.
Carrier gas: helium
Flow rate: 2 ml/min.
MS range: 35-500

If the thermal decomposition temperature is too high, the quality of the separator material subjected to measurement is greatly altered, thereby the material cannot be accurately measured, and if the thermal decomposition temperature is less than a temperature where sufficient thermal decomposition can be performed, the material cannot be accurately measured. Therefore, the thermal decomposition is preferably performed within an appropriate temperature range. In the case of the separator of the embodiment which includes polyethylene as a main material, the thermal decomposition is preferably performed within a range from 400° C. to 750° C., and more preferably within a range from 550° C. to 650° C.

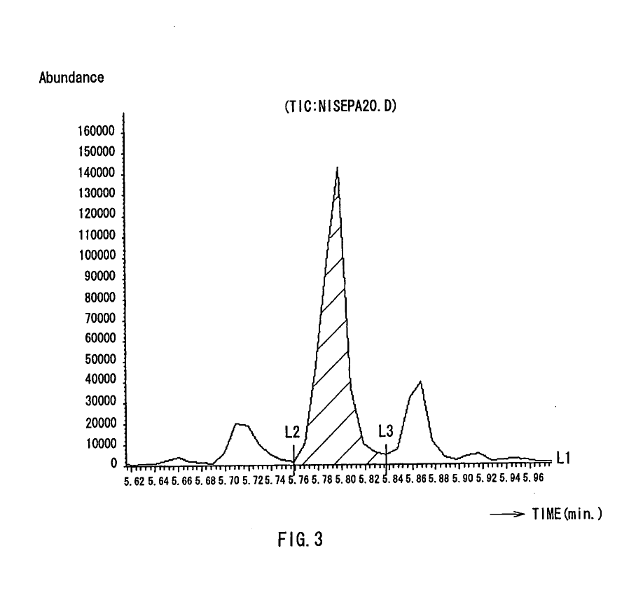

Herein, as the definition of the above “the area of a peak”, in the total ion chromatogram of the pyrolysate of the separator which is obtained when measuring under “Condition 1”, MS spectra A, B and C each corresponding to each peak are integrals of Peaks 1, 2 and 3 attributed to 1-Decene, 1-Octene and 1-Nonene, respectively. In other words, as shown in a diagonally shaded area of FIG. 3 as an example, the integral in this case is defined as an area enclosed with a direct line (L1) indicating approximately 0 in abundance, vertical lines (L2 and L3) extending from the minimum abundance point between each targeted peak and a peak adjacent to the targeted peak to the bottom (L1), and a peak value (apex).

Through such a step of evaluating, in the nonaqueous secondary battery comprising the anode, the cathode and the nonaqueous electrolyte, the separator which is accurately evaluated and selected before completing the secondary battery can be disposed between the cathode and the anode. Thereby, the nonaqueous secondary battery manufactured by using the separator which is evaluated and selected by the step of evaluating according to the embodiment comprises a separator with superior high temperature characteristics, so the secondary battery has superior high temperature charge-discharge cycle characteristics and a higher energy density.

### EXAMPLES

Next, examples (and comparative examples) of the step of evaluating a separator according to the invention will be described below. Secondary batteries in the examples each have a coin shape. However, a secondary battery with any other shape such as a cylindrical shape can have the same result.

Various separator materials used in the examples were measured under the conditions described in Condition 1 by thermal decomposition+GC/MS. Main measuring procedures are (1) wrap the separator in pyrofoil, (2) put the pyrofoil in a quartz tube, and place the quartz tube in a pyrolyzer (JHP-3 manufactured by Japan Analytical Industry Co., Ltd.), (3) thermally decompose the separator at 590° C. for 12 seconds by applying a high frequency; and (4) measure a pyrolysate by GC/MS.

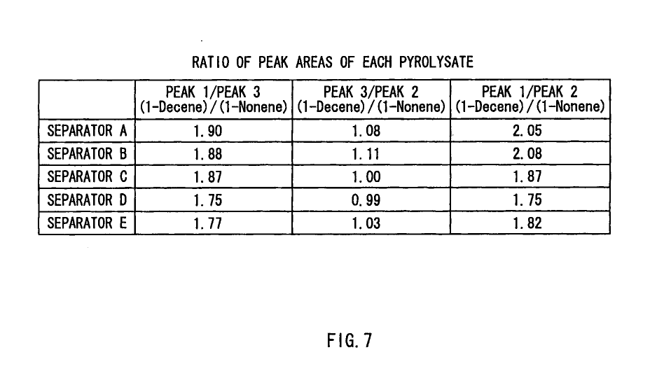

MS spectra obtained by the above measurement were analyzed. An interrelationship of integrals of peaks (areas of peaks) attributed by 1-Decene, 1-Nonene and 1-Octene is shown in FIG. 7.

At first, 89.5 parts by weight of artificial graphite and 0.5 parts by weight of acetylene black as the anode active materials, 10 parts by weight of polyvinylidene fluoride (PVdF) as a binder were mixed to form an anode mixture. The anode mixture was dispersed in N-methyl-2-pyrrolidone to form slurry. After the slurry was applied to a current collector made of copper foil, and was dried, the slurry was compression molded by a roller press. At that time, the thickness of the anode except for the current collector made of copper foil was 150 μm. The anode was stamped into a pellet with a diameter of 15.5 mm.

On the other hand, the cathode was formed as follows. In order to obtain a cathode active material (LiCoO₂), lithium carbonate and cobalt carbonate were mixed at a ratio of 0.5 mol:1 mol, and the mixture was fired in air at 900° C. for 5 hours. Next, 91 parts by weight of the obtained LiCoO₂, 6 parts by weight of graphite as an electrical conductor and 3 parts by weight of polyvinylidene fluoride (PVdF) as a binder were mixed to form a cathode mixture. The cathode mixture was dispersed in N-methyl-2-pyrrolidone to form slurry. After the slurry was uniformly applied to aluminum foil which was a cathode current collector, and was dried, the slurry was compression molded by a roller press. At that time, the thickness of the cathode except for the current collector made of aluminum foil was 150 μm. The cathode was stamped into a pellet with a diameter of 15.5 mm.

The used nonaqueous electrolyte was formed through dissolving 1.0 mol/1 of LiPF₆ in a mixed solvent including 50% by volume of ethylene carbonate (EC) and 50% by volume of diethyl carbonate.

The obtained cathode, the obtained anode and a separator A made of a microporous polyethylene film with a thickness of 25 μm were laminated in order, and the above electrolyte solution was injected to form a coin-type cell with a diameter of 20 mm and a height of 2.5 mm (not shown) as Comparative Example 1. A coin-type cell comprising a separator B was formed as Comparative Example 2 in the same manner.

Coin-type cells comprising separators C, D and E were formed as Example 1, Example 2 and Example 3, respectively.

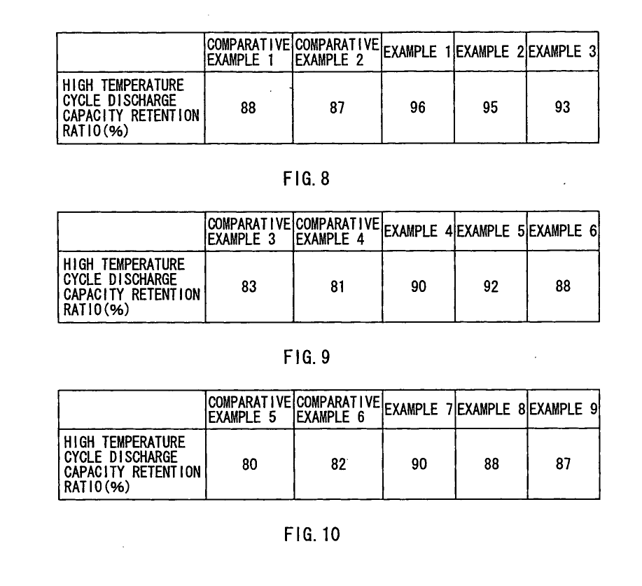

The cycle characteristics of secondary batteries of Examples 1, 2 and 3 and Comparative Examples 1 and 2 were evaluated as follows. At first, after each battery was charged at a constant current of 1 mA at 45° C. until a battery voltage reached 4.2 V, the battery was charged at a constant voltage of 4.2 V until an end current reached 0.05 mA, and then the battery was discharged at a constant current of 1 mA until an end voltage reached 2.5 V. Under the same charge-discharge conditions, 100 charge-discharge cycles were carried out, and the discharge capacity retention ratio (%) in the 100th cycle was determined in the case where the discharge capacity in the first cycle was 100. The results are shown in FIG. 8. As shown in FIG. 8, it was confirmed that in the nonaqueous secondary battery comprising the anode, the cathode, the separator and the nonaqueous electrolyte, in Examples 1, 2 and 3, the nonaqueous secondary batteries with a high temperature cycle discharge capacity retention ratio of 90% or more, that is, superior high temperature cycle characteristics could be obtained. On the other hand, in the secondary batteries of Comparative Examples 1 and 2, the high temperature cycle discharge capacity retention ratio was less than 90%.

Next, the same coin-type cell as that of Comparative Example 1 except that the total thickness of the cathode was 150 μm, and the total thickness of the anode was and 80 μm was formed as Comparative Example 3. When the secondary battery of Comparative Example 3 was disassembled after the secondary battery was fully charged, precipitation of a lithium metal on the surface of graphite on the anode side was confirmed by visual inspections and ⁷Li nuclear magnetic resonance spectroscopy.

Next, a coin-type cell was formed as Comparative Example 4 through the same method as that in Comparative Example 3, except that the separator B was used. Moreover, coin-type cells were formed through the same method as that in Comparative Example 3, except that the separators C, D and E were used, as Examples 4, 5 and 6, respesctively.

The cycle characteristics of the batteries of Examples 4 through 6 and Comparative Examples 3 and 4 were evaluated as follows. After each battery was charged at a constant current of 1 mA at 45° C. until a battery voltage reached 4.2 V, the battery was charged at a constant voltage of 4.2 V until an end current reached 0.05 mA, and then the battery was discharged at a constant current of 1 mA until an end voltage reached 2.5 V. Under the same charge-discharge conditions, 100 charge-discharge cycles were carried out, and the discharge capacity retention ratio (%) in the 100th cycle was determined in the case where the discharge capacity in the first cycle was 100. As a result, as shown in FIG. 9, it was confirmed that in Examples 4, 5 and 6, the nonaqueous secondary batteries with a high temperature cycle discharge capacity retention ratio of 85% or more, that is, superior high temperature cycle characteristics could be obtained. On the other hand, in the secondary batteries of Comparative Examples 3 and 4, the high temperature cycle discharge capacity retention ratio was less than 85%.

Next, examples in the case where a metal capable of forming an alloy with lithium is used as the anode active material will be described below.

At first, the anode was formed as follows. A mixture including 45 g of Sn powder and 55 g of Cu powder was put into a quartz board to be heated in an argon gas atmosphere at 1000° C., and then the mixture was left standing to cool to room temperature. The obtained lumps were pulverized in an argon gas atmosphere with a ball mill to obtain powder. The obtained powder was measured with a laser diffraction particle size distribution analyzer manufactured by Horiba, the average particle diameter was approximately 10 μm. Then, 54.5 parts by weight of the Cu—Sn powder, 0.5 parts by weight of acetylene black, 35 parts by weight of artificial graphite and 10 parts by weight of polyvinylidene fluoride (PVdF) as a binder were mixed to form a mixture, and the mixture was dispersed in N-methyl-2-pyrrolidone as a solvent to form slurry. After the slurry was applied to a current collector made of copper foil, and was dried, the slurry was compression molded by a roller press, and the current collector was stamped into a pellet with a diameter of 15.5 mm.

The cathode was formed as in the case of Example 1, and the same nonaqueous electrolyte as that in Example 1 was used. The obtained cathode, the obtained anode and the separator A made of a microporous polyethylene film with a thickness of 25 μm were laminated in order, and the same electrolyte solution as that in Example 1 was injected to form a coin-type cell with a diameter of 20 mm and a height of 2.5 mm as Comparative Example 5. A coin-type cell was formed as Comparative Example 6 through the same method as that in Comparative Example 5 except that the separator B was used. Moreover, coin-type cells were formed through the same method as that in Comparative Example 5, except that the separators C, D and E were used, as Examples 7, 8 and 9, respectively.

The cycle characteristics of the secondary batteries of Examples 7 through 9 and Comparative Examples 5 and 6 were evaluated as follows. After each battery was charged at a constant current of 1 mA at 45° C. until a battery voltage reached 4.2 V, the battery was charged at a constant voltage of 4.2 V until an end current reached 0.05 mA, and then the battery was discharged at a constant current of 1 mA until an end voltage reached 2.5 V. Under the same charge-discharge conditions, 100 charge-discharge cycles were carried out, and the discharge capacity retention ratio (%) in the 100th cycle was determined in the case where the discharge capacity in the first cycle was 100. As a result, as shown in FIG. 10, it was confirmed that in the nonaqueous secondary battery comprising the anode, the cathode, the separator and the nonaqueous electrolyte, in Examples 7 through 9, the nonaqueous secondary batteries with a high temperature cycle discharge capacity retention ratio of 85% or more, that is, superior high temperature cycle characteristics could be obtained. On the other hand, in the secondary batteries of Comparative Examples 5 and 6, the high temperature cycle discharge capacity retention ratio was less than 85%.

As shown in the examples and the comparative examples, it was confirmed that in the method of manufacturing a secondary battery comprising the step of evaluating a separator according to the invention and the secondary battery according to the invention, in the nonaqueous secondary battery comprising the anode, the cathode and the nonaqueous electrolyte, the separator accurately evaluated and selected before completing the secondary battery could be disposed between the cathode and the anode. Moreover, it was confirmed that the nonaqueous secondary battery manufactured by using the separator evaluated and selected by the step of evaluating a separator comprised a separator which could exhibit superior high temperature characteristics when the separator was included in the secondary battery, so the secondary battery had superior high temperature charge-discharge cycle characteristics and a higher energy density.

For example, the invention can be applied to a method of manufacturing a secondary battery comprising the step of evaluating a separator used in a secondary battery such as a nonaqueous secondary battery comprising an anode capable of doping and undoping lithium, a cathode, a separator disposed between the cathode and the anode and a nonaqueous electrode, and a secondary battery.

Obviously many modifications and variations of the present invention are possible in the light of the above teachings. It is therefore to be understood that within the scope of the appended claims the invention may be practiced otherwise than as specifically described.

1. A secondary battery, comprising:
an anode;
a cathode; and
a separator disposed between the anode and the cathode,
wherein the value of the integral of Peak 1 exhibiting an MS spectrum of 1-Decene/the integral of Peak 2 exhibiting an MS spectrum of 1-Octene as a ratio between the integral of Peak 1 and the integral of Peak 2 in a total ion chromatogram of the pyrolysate of a material of the separator is 2.00 or less.

2. A secondary battery according to claim 1, wherein
the value of the integral of Peak 3 exhibiting an MS spectrum of 1-Nonene/the integral of Peak 2 exhibiting an MS spectrum of 1-Octene as a ratio between the integral of Peak 3 and the integral of Peak 2 in the total ion chromatogram of the pyrolysate of the material of the separator is 1.05 or less.

3. A secondary battery according to claim 2, wherein
the value of the integral of Peak 1 exhibiting an MS spectrum of 1-Decene/the integral of Peak 3 exhibiting an MS spectrum of 1-Nonene as a ratio between the integral of Peak 1 and the integral of Peak 3 in the total ion chromatogram of the pyrolysate of the material of the separator is 1.87 or less.

4. A secondary battery according to claim 1, wherein
the separator includes polyethylene as a main material.

5. A secondary battery according to claim 1, wherein
the secondary battery is a nonaqueous secondary battery comprising a nonaqueous electrolyte.

6. A secondary battery according to claim 1, wherein
the secondary battery is a nonaqueous secondary battery using a carbonaceous material capable of inserting and extracting lithium as a material of the anode.

7. A secondary battery according to claim 1, wherein
the secondary battery is a nonaqueous secondary battery using a carbonaceous material, a non-graphitizable carbon material, a graphitizable carbon material or a graphite material as a material of the anode.

8. A secondary battery according to claim 1, wherein
the secondary battery is a nonaqueous secondary battery comprising an anode active material made of a material including a metal or a metal compound capable of forming an alloy with lithium.

9. A secondary battery according to claim 1, wherein
the secondary battery is a nonaqueous secondary battery comprising an anode active material made of a material including a metal which is a Group 4B representative element or a compound of the metal.

10. A secondary battery according to claim 9, wherein
as the Group 4B representative element, Si (silicon) or Sn (tin) is used.

11. A secondary battery according to claim 5, wherein
the capacity of the anode is represented by the sum of a capacity component by insertion and extraction of a light metal and a capacity component by precipitation and dissolution of the light metal, and the light metal is Li (lithium).

12. A method of manufacturing a secondary battery, comprising the step of:
evaluating the chemical structure of a separator material disposed between an anode and a cathode in a secondary battery by thermal decomposition gas chromatography (thermal decomposition+GC/MS) to select a material used as a separator in the secondary battery on the basis of evaluation,
wherein the chemical structure of the separator material is evaluated on the basis of a total ion chromatogram of the pyrolysate of the separator material.

13. A method of manufacturing a secondary battery according to claim 12, wherein
a material in which the value of the integral of Peak 1 exhibiting an MS spectrum of 1-Decene/the integral of Peak 2 exhibiting an MS spectrum of 1-Octene as a ratio between the integral of Peak 1 and the integral of Peak 2 in the total ion chromatogram of the pyrolysate of a material of the separator is 2.00 or less is evaluated as a material with a chemical structure required for the separator.

14. A method of manufacturing a secondary battery according to claim 13, wherein
a material in which the value of the integral of Peak 3 exhibiting an MS spectrum of 1-Nonene/the integral of Peak 2 exhibiting an MS spectrum of 1-Octene as a ratio between the integral of Peak 3 and the integral of Peak 2 in the total ion chromatogram of the pyrolysate of the material of the separator is 1.05 or less is evaluated as a material with a chemical structure required for the separator.

15. A method of manufacturing a secondary battery according to claim 14, wherein
a material in which the value of the integral of Peak 1 exhibiting an MS spectrum of 1-Decene/the integral of Peak 3 exhibiting an MS spectrum of 1-Nonene as a ratio between the integral of Peak 1 and the integral of Peak 3 in the total ion chromatogram of the pyrolysate of the material of the separator is 1.87 or less is evaluated as a material with a chemical structure required for the separator.

16. A method of manufacturing a secondary battery according to claim 13, wherein
the separator includes polyethylene as a main material.

17. A method of manufacturing a secondary battery according to claim 12, wherein
the secondary battery is a nonaqueous secondary battery comprising a nonaqueous electrolyte.

18. A method of manufacturing a secondary battery according to claim 12, wherein
the secondary battery is a nonaqueous secondary battery using a carbonaceous material capable of inserting and extracting lithium as a material of the anode.

19. A method of manufacturing a secondary battery according to claim 12, wherein
the secondary battery is a nonaqueous secondary battery using a carbonaceous material, a non-graphitizable carbon material, a graphitizable carbon material or a graphite material as a material of the anode.

20. A method of manufacturing a secondary battery according to claim 12, wherein
the secondary battery is a nonaqueous secondary battery comprising an anode active material made of a material including a metal or a metal compound capable of forming an alloy with lithium.

21. A method of manufacturing a secondary battery according to claim 12, wherein
the secondary battery is a nonaqueous secondary battery comprising an anode active material made of a material including a metal which is a Group 4B representative element or a compound of the metal.

22. A method of manufacturing a secondary battery according to claim 21, wherein
the secondary battery uses Si (silicon) or Sn (tin) as the Group 4B representative element.

23. A method of manufacturing a secondary battery according to claim 17, wherein
in the secondary battery, the capacity of the anode is represented by the sum of a capacity component by insertion and extraction of a light metal and a capacity component by precipitation and dissolution of the light metal, and the light metal is Li (lithium).
